(19) United States
(12) Patent Application Publication
(10) Pub. No.: US 2014/0263888 A1
(43) Pub. Date: Sep. 18, 2014

(54) HANGING SHOE HOLDER

(71) Applicant: Mark Richard Robelli, Clinton Township, MI (US)

(72) Inventor: Mark Richard Robelli, Clinton Township, MI (US)

(21) Appl. No.: 13/794,788

(22) Filed: Mar. 12, 2013

(51) Int. Cl. F16M 13/02

(52) U.S. Cl. CPC F16M 13/02
USPC 248/205.1

(57) ABSTRACT

A hanging shoe holder (10) is disclosed for a single pair of shoes, for applying to any vertical surface; such as a wall or door. The invention's function is to be a convenient, space saving device to store a pair of shoes. The hanging shoe holder comprises of two adjacent, parallel, elongated shoe cups (12) (14). Each shoe cup has a left wall (16) and a right wall (18) for preventing a shoe from falling out. The walls of the shoe cups extend upward and blend into the frame (20) of the holder. The hanging shoe holder has an oval shape and may be manufactured from conventional materials like plastic and rubber.

### BACKGROUND

1. Prior Art

The following is a tabulation of some prior art that presently appears relevant:

U.S. patents

| Pat. No. | Kind Code | Issue Date | Patentee |
|---|---|---|---|
| 7,861,870 | B2 | Jan. 4, 2011 | Chiang |
| 5,894,940 | N/A | Apr. 20, 1999 | Gusdorf et al. |
| 4,036,367 | N/A | Jul. 19, 1977 | Stambaugh et al. |
| 3,468,426 | N/A | Sep. 23, 1969 | Loewy |
| 2,090,108 | N/A | Aug. 17, 1937 | Cicero |
| 953130 | N/A | Mar. 29, 1910 | Fellows |

2. Background of the Invention

This invention relates to shoe racks. More particularly, toward a hanging shoe holder that can hold a single pair of shoes, which can adhere to any vertical surface, without the use of hooks and nails. Shoes will be held in two adjacent elongated shoe cup holders, in an upright manner. To the best of Applicant's knowledge and research, no one has developed a shoe holder of this nature.

Retail stores and online stores sell many different kinds of shoe storage products to consumers. They consist of shoe racks that stand on the floor, hang over doors, shoe holders that hang from closet rods and shoe container boxes. These shoe storage devices can hold many pairs of shoes; but are large, unattractive, and can be costly to manufacture. Furthermore, many of these shoe storage products require the consumer to assemble the product. Assembly can deter a consumer from buying the product, and assembly can waste the consumer's time and energy.

Nonetheless, the shoe holders and shoe racks that hang on doors and closet doors have become very popular. They are popular because they allow shoes to be conveniently stored in a space that is otherwise not used. This allows people to have more walking space and space that can be used for other things, or simply empty space.

Shoe storage products that stand or rest on a floor serve the purpose of storing shoes, but they also cause problems. They are often bumped into by people when they are walking. People often trip over these shoe storage products because they take up too much floor space. An example of this are U.S. Pat. No. 7,861,870 to Chiang (2011) and U.S. Pat. No. 4,036,367 to Stambaugh et al. (1977). A common complaint among people who live in small spaces, such as college students living in dorm rooms, is that there is not enough space, especially floor space.

College students do not have the floor space for the standard types of shoe racks. They also do not like the shoe holders that hang over doors, as these products have too many unneeded shoe holders. Students usually have two or three pairs of shoes maximum. College students also complain that these types of shoe storage devices are not “cool looking” or they are not attractive. An example of this is U.S. Pat. No. 5,894,940 to Gusdorf et al. (1999).

College students who live in small dorm rooms are looking for a smart, space saving, and convenient way to store their shoes. People who live in small apartments are also looking for a smart, space saving, and convenient way to store their shoes. They want a shoe storage product that will not take up any floor space and is also attractive. Another disadvantage of floor shoe racks is that many people do not like bending down to retrieve their shoes. An example of this are senior citizens. Their bodies are not as flexible as when they were younger, and bending down can be difficult. Today, many people simply do not buy shoe storage products for the reasons listed above.

Some other prior art U.S. patents are U.S. Pat. No. 3,468,426 to Loewy (1969), U.S. Pat. No. 2,090,108 to Cicero (1937), and U.S. Pat. No. 953,130 to Fellows (1910). These patents are shoe racks that are placed on a vertical surface; such as a wall or door, by means of bolts, nails and screws. Thus damaging the surface that the shoe rack is attached to.

It will be more apparent in the following text of the application, that the applicant has invented a new, novel and useful item.

### SUMMARY

In view of the foregoing disadvantages inherent in the known types of shoe storage products now present in the prior art, the present invention provides a new and smarter way to store shoes. One will use a vertical surface such as a wall or door to store their shoes. It is, therefore, among the principal objects of the present invention to provide a shoe storage device, that will not damage vertical surfaces comprising of: a substantially oval shaped frame and two adjacent elongated shoe cups.

### ADVANTAGES

Accordingly several advantages of one or more aspects are as follows: to provide consumers with a space saving shoe storage product, that will not damage walls or doors, that requires no hooks or nails, that is easy to apply and remove, that is one piece and no assembly required, that is convenient to retrieve shoes, that is attractive (Applicant understands attractiveness is subjective to each individual, Applicant's trademark will compliment and add to invention's attractiveness), that will be relatively inexpensive, and that can be easily manufactured. Other advantages of one or more aspects will be apparent from a consideration of the drawings and ensuing description.

### BRIEF DESCRIPTION OF THE DRAWINGS

For the purpose of illustrating the invention, there is shown in the accompanying drawings one form which is presently preferred; it being understood that the invention is not intended to be limited to the precise shape shown. The figures are not necessarily drawn to scale and are not intended to serve as engineering drawings.

FIG. 1 is a front perspective view of the hanging shoe holder.

FIG. 2 is a front view similar to FIG. 1 but more direct.

FIG. 3 is a side view.

FIG. 4 is a back view of the hanging shoe holder.

FIG. 5 is a back view similar to FIG. 4 but with an adhesive strip, for applying the invention to a vertical surface.

FIGS. 6, 7 and 8 are front perspective views of the invention, demonstrating various shoes in the invention.

### DESCRIPTION OF THE PREFERRED EMBODIMENTS

The hanging shoe holder in accordance with preferred embodiments will now be described making reference to the figures. The figures are intended to be illustrative rather than limiting and are included to facilitate the explanation of features of the embodiments of the invention. The figures are not necessarily drawn to scale, and as stated previously, not intended to serve as engineering drawings.

Referring now to the drawings, and in particular to FIG. 1, wherein like numerals indicate like elements. There is shown a new invention, a hanging shoe holder, designated by the reference numeral 10, hanging from a vertical surface, such as a wall or door. Constructed according to a preferred embodiment of the present invention.

As best illustrated in FIGS. 1 through 3, the hanging shoe holder 10 comprises of a left shoe cup 12 and a right shoe cup 14, each shoe cup has a left wall 16 and a right wall 18 for preventing a shoe from falling out of the shoe cup. The shoe cup walls extend upward and then blend into the frame 20 of the hanging shoe holder.

The hanging shoe holder is substantially oval shaped, includes an oval frame, and two adjacent, parallel, elongated convex shaped shoe cups for holding a single pair of shoes. In one embodiment, the hanging shoe holder is constructed of a solid plastic, such as polypropylene. This is presently the preferred embodiment. However, the hanging shoe holder can consist of any material that is solid; but not limited to acrylonitrile butadiene styrene, ethylene vinyl acetate, polyacetal, polyamide, polycarbonate, polyvinyl chloride, polyetheretherketone, polyethylene, polyphenylene, polyphenylene, polyurethane, urethane, etc.

The invention will be manufactured in a rubber-like thermo-plastic material (colored) using the Injection Mold Process. This is a closed molded process, with Computerized Numerical Control (CNC) cut P20 Steel-core and cavity half modes, constructed from mathematical data created from the Computer Aided Design (CAD) of the product. The end result will be a colored, molded part, that will require no trimming or finishing after molding, and require only production packaging. The stages of injection mold are as follows: 1. Determine the shrink of the part material to be used in production and expand the Design File the same amount. 2. Create in CAD, the injection mold 3D tool design using typical standards. 3. Order the necessary steel and hardware components for the tool build. 4. Create the CNC toolpaths that will ultimately cut the core and cavity halves and any slides or lifters if applicable. Finish all CNC cut mold surfaces, remove the cusp. 6. Install remaining hardware and mold components, (sprue, sprue ring, ejection, water fittings etc.). 7. Spotting of the Core and Cavity half mode to ensure a proper shut-off. 8. Tryout of the hanging shoe holder mold and molded part quality inspection.

It is to be understood that the present invention is not limited to the precise method listed above, and changes are contemplated as readily fall within the spirit of the invention. It should be readily apparent to those skilled in the art, that other mold making processes could be used.

The overall thickness of the entire hanging shoe holder is typically 5-8 mm. The height is typically 12-14 inches. The length is typically 10-12 inches. The shoe cups are typically oval, rounded, convex shaped at their apex, making the width of the holder typically 4-6 inches. It is to be understood that the present invention is not limited to the preferred embodiments listed above.

### Operation

The manner of using the hanging shoe holder is quite simple. Applicant's prototype has been tested and works. The present invention will hang from a wall, door or other similar surface by an adhesive strip that is applied to the back of the hanging shoe holder FIG. 4. After the manufactured product is made, the adhesive strip will be applied to the product as shown in FIG. 5. Applicant has included the adhesive strip in the drawings for the sole purpose of showing how the invention is applied to a vertical surface. One simply peels the plastic liner off the adhesive strip, thus exposing the adhesive. One then chooses where he or she would like to place the hanging shoe holder. One then presses the hanging shoe holder against a vertical surface such as a wall, using firm pressure.

After the hanging shoe holder is on a wall, door, or similar surface; one simply places their shoes in an upright manner in the invention. One can lace their shoes in heel first, toe first, sideways or whatever way one desires. FIGS. 6, 7 and 8 demonstrate the shoes in heel first. Applicant believes this method is best, as it also shows the front and top one's pair of shoes. College students have expressed their opinion that they like this method also, and like their laces hanging down from the shoe cups. The hanging shoe holder can be removed from a vertical surface by simply gripping the product with both hands, and pulling it slowly away from the vertical surface with average force.

Although the present invention has been described in terms of the foregoing preferred embodiments, this description has been provided by way of explanation only, and is not intended to be construed as limitation of the invention. Those skilled in the art will recognize modifications of the present invention that might accommodate different forms, such as different shapes for the shoe cups and different shapes for the frame. Such modifications, as well as changes to size, structure, materials, and methods of manufacture of the hanging shoe holder, do not necessarily depart from the spirit and scope of the invention.

I claim:

1. A hanging shoe storage device for holding a single pair of shoes on a vertical surface, such as a wall or door, comprising:
a. a shaped frame,
b. two shoe cups.

2. The hanging shoe storage device of claim 1 wherein said device has an oval shape.

3. The hanging shoe storage device of claim 1 wherein said device is made of plastic.

4. The hanging shoe storage device of claim 1 wherein said device is made of rubber.

5. The hanging shoe storage device of claim 1 wherein said device is made of plastic and rubber.

6. The hanging shoe storage device of claim 1 wherein said device is made of any solid material.
